(19) United States
(12) Patent Application Publication
(10) Pub. No.: US 2010/0159111 A1
(43) Pub. Date: Jun. 24, 2010

(54) COOKWARE RELEASE COMPOSITIONS AND METHODS EMPLOYING SAME

(75) Inventors: Linsen LIU, Irvine, CA (US); Serpil Metin, Eden Prairie, MN (US); Patrick Moran, Little Canada, MN (US)

Correspondence Address: CARGILL, INCORPORATED, P.O. Box 5624, MINNEAPOLIS, MN, 55440-5624, US

(73) Assignee: CARGILL, INCORPORATED, Wayzata, MN (US)

(21) Appl. No.: 12/644,131

(22) Filed: Dec. 22, 2009

Related U.S. Application Data
(60) Provisional application No. 61/203,413, filed on Dec. 23, 2008.

(51) Int. Cl. A23D 9/00; A23L 1/01

(52) U.S. Cl. 426/609; 426/523

(57) ABSTRACT

This disclosure provides cookware release compositions and methods of cooking using a cookware release composition. Some of these cookware compositions exhibit reduced oil polymerization and/or easier washing of cookware coated with the composition.

### CROSS REFERENCE TO RELATED APPLICATIONS

This application claims the benefit of U.S. Provisional Application No. 61/203,413, filed 23 Dec. 2008 and entitled “Cookware Release Composition Comprising A High Oleic Vegetable Oil And A Lecithin Composition”, the entirety of which is incorporated herein by reference.

### FIELD

The present invention relates to cookware release compositions that comprise a high oleic vegetable oil and a lecithin composition.

### BACKGROUND

It is known to use conventional vegetable oils like canola oil and soybean oil in cookware release compositions. These oils naturally contain sites of unsaturation (i.e., carbon-carbon double bonds) that may serve as reactive sites in polymerization of the composition.

Polymerization of the cooking composition is undesirable since the polymerized composition may be difficult to remove from the cooking surface using normal washing routines. This can lead to appreciable build-up of polymerized material on cookware over time in commercial production. Additionally, the food item that is cooked may stick to the cookware, making it difficult to remove the food item from the cookware without damaging the appearance of the food item. Browning of the cookware release composition is also an undesirable property since the brown color may be imparted to the food article causing an undesirable brown appearance. In view of the foregoing, cookware release compositions that display improved resistance to polymerization and resistance to browning are desired.

### SUMMARY

The present disclosure relates to cookware release compositions, methods of reducing polymerization of cookware release compositions, and methods of cooking using cookware release compositions. Aspects of the invention contemplate cookware release compositions comprising high oleic vegetable oils. Despite having an increased amount of oleic acid which includes a polymerizable double bond, it has been surprisingly discovered that cookware release compositions of the invention comprising high oleic vegetable oils display improved properties including, in some embodiments, improved resistance to polymerization, resistance to browning, and highly effective non-stick properties. Resistance to polymerization allows the cookware release compositions to be readily cleaned from a cooking surface after cooking.

In one aspect, the invention provides a cookware release composition comprising (i) a high oleic vegetable oil composition comprising canola oil, sunflower oil, or a mixture thereof having about 70% wt. or greater oleic acid; and (ii) about 0.5 to 12% wt. of a lecithin composition, based on the total weight of the high oleic vegetable oil composition and the lecithin composition. The cookware release composition is capable of being coated on a generally smooth aluminum cooking surface, held at a temperature of about 290° F. for about 5 minutes or greater, and having at least about 70% or greater of the cookware release composition washed off by the Washing Evaluation Test as described herein.

In another aspect, the invention provides a method of reducing polymerization of a cookware release composition during cooking at a cooking temperature of about 290° F. for a cooking time of at least about 5 minutes or greater. The method comprises applying to a cooking surface a cookware release composition that comprises (i) a high oleic vegetable oil composition comprising canola oil, sunflower oil, or a mixture thereof having an oleic acid content of about 70% wt. or greater; and (ii) about 0.5 to 12% wt. lecithin composition, based on the total weight of the high oleic vegetable oil composition and the lecithin composition.

In yet another aspect, the invention provides a cooking method comprising (a) applying a cookware release composition to a cooking surface of a substrate to provide a coated surface, the cookware release composition comprising (i) a high oleic vegetable oil composition comprising canola oil, sunflower oil, or a mixture thereof and having an oleic acid content of about 70% wt. or greater; and (ii) about 0.5 to 12% wt. lecithin composition, based on the total weight of the high oleic vegetable oil composition and lecithin composition: (b) heating the substrate and the applied cookware release composition at a temperature of at least about 290° F. for about 5 minutes or greater; and (c) washing the coated surface. In some embodiments, the method further comprises the step of depositing a food on the coated surface, wherein heating the substrate and the applied cookware release composition further comprises heating the food.

In yet another aspect, the invention provides a cookware release composition comprising (a) a high oleic vegetable oil composition; and (b) a lecithin composition that comprises (i) one or more types of standard lecithin; and (ii) one or more types of modified lecithin selected from the group consisting of hydrolyzed lecithin, acetylated lecithin, fractionated lecithin, deoiled lecithin, and hydroxylated lecithin.

In yet another aspect, the invention provides a method for producing a cookware release composition, comprising combining a high oleic vegetable oil, a first lecithin component, and a second lecithin component, wherein the first lecithin component comprises a standard lecithin and the second lecithin component comprises at least one modified lecithin that has been reacted to modify at least one functional group of at least about 20% of the phosphatides.

In some embodiments, the lecithin composition comprises (i) one or more types of standard lecithin and (ii) one or more types of modified lecithins. Examples of modified lecithin include hydrolyzed lecithin, acetylated lecithin, and hydroxylated lecithin. In exemplary embodiments, the lecithin composition comprises standard lecithin and hydrolyzed lecithin or standard lecithin and hydroxylated lecithin. Other combinations of standard and modified lecithin may also be useful.

High oleic vegetable oils (as defined below) useful in the invention include those having about 63% wt. or greater oleic acid and also those having about 15% wt. or less saturated fatty acids, with the acid percentages being based on the total weight of fatty acids in the vegetable oil. In some embodiments, the high oleic vegetable oil comprises about 70% wt. or greater, about 75% wt. or greater, or about 80% wt. or greater oleic acid. In some embodiments, the high oleic vegetable oil comprises about 9% wt. or less saturated fatty acids or about 6% wt. or less saturated fatty acids. In some embodiments, the high oleic vegetable oils comprise about 4.0% wt or less linolenic acid. Representative examples of high oleic vegetable oils include high oleic canola oil, high oleic sunflower oil, high oleic soy, high oleic safflower oil, olive oil, olive-pomance oil, and mixtures thereof. In an exemplary embodiment, the high oleic vegetable oil comprises high oleic canola oil.

In some embodiments, the cookware release composition comprises about 89 to 97% wt. high oleic vegetable oil; and about 3 to 11% wt. lecithin composition comprising (a) standard lecithin and (b) one or more modified lecithins selected from hydrolyzed lecithin and hydroxylated lecithin. In yet other embodiments, the cookware release composition comprises about 89 to 97% wt. high oleic canola oil: about 1 to 7% wt. standard lecithin; and about 2 to 7% % wt. modified lecithin. The above-listed percentages are based upon the total weight of the high oleic vegetable oil composition and lecithin composition, but not including any optional ingredients such as anti-foaming agents, food grade blocking agents, flavoring agents, preservatives, antioxidants, emulsifying agents, coloring agents, food grade alcohols, water, crystallization-inhibiting agents, and viscosity-reducing agents.

### BRIEF DESCRIPTION OF THE FIGURES

FIG. 1 is a graph displaying percent of baked composition removed by washing for various oil and oil/lecithin blends.

FIG. 2 is a graph displaying percent of baked composition removed by washing for various oil/lecithin blends.

FIG. 3 is a graph displaying change in viscosity (Pas) versus time of exposure to elevated temperature (146° C.) for various oils and oil/lecithin blends.

FIG. 4 is a graph displaying percentage of baked composition removed by washing for various oils and oil/lecithin blends.

### DETAILED DESCRIPTION

In the following description, reference is made to specific embodiments in which the invention may be practiced. It is to be understood that other embodiments may be utilized as changes may be made without departing from the scope of the present invention.

As noted above, the present disclosure provides cookware release compositions. In many embodiments, the cookware release compositions of the invention comprise a high oleic vegetable oil composition and a lecithin composition. In some embodiments, the lecithin composition comprises one or more types of standard lecithin and one or more types of modified lecithin.

Embodiments of the cookware release compositions of the invention display improved properties as compared to known cookware release compositions including, for example, inhibition of browning, resistance to polymerization (film forming), and improved food release (i.e., non-stick property). The resistance to polymerization is surprising particularly in view of the fact that the compositions of the invention comprise a high content of oleic acid, which includes polymerizable double bonds in the acyl portion of the triglyceride structure.

The components making up the cookware release compositions of the invention are described in further detail below.

High Oleic Vegetable Oil Composition: Cookware release compositions of the invention contain a high oleic vegetable oil composition comprising one or more high oleic vegetable oils. High oleic vegetable oil refers to a vegetable oil that comprises about 63% wt. or greater oleic acid (i.e., a monounsaturated 18-carbon acid moiety, commonly referred to as C18:1). In some embodiments, the high oleic vegetable oil comprises about 70% wt. or greater oleic acid, or about 80% wt. or greater oleic acid. In some embodiments, the high oleic vegetable oil comprises about 4.0% wt or less linolenic acid. In some embodiments, the high oleic vegetable oil comprises about 15% wt. or less saturated fatty acids, for example, about 9% wt. or less saturated fatty acids. In the compositions described above, the fatty acid percentages are based on the total weight of fatly acids in the high oleic vegetable oil and may be determined using AOCS Official Method Ce Ic-89.

In exemplary embodiments, the high oleic vegetable oil comprises high oleic canola oil. Non-limiting examples of commercially available liquid canola oils include those available under the trade designations “CLEAR VALLEY 65” (CV 65) and “CLEAR VALLEY 75” (CV 75), from Cargill. Incorporated (Wayzata Minn.). Also useful are the high oleic canola oils commercially available under the trade designations “ODYSSEY 90” (OD90) and “ODYSSEY 95” (OD95). CV65 and CV75 are refined, bleached and deodorized oils produced from seeds of high-oleic acid, low α-linolenic acid (“HOLL”) Brassica napus plant lines.

In some embodiments, the high oleic vegetable oil comprises high oleic sunflower oil. In some embodiments, high oleic sunflower oil comprises about 80% wt. or greater oleic acid. Non-limiting examples of commercially available high oleic sunflower oil include those available under the trade designations “CLEAR VALLEY HOSUN” (CV HOSUN) and “ODYSSEY 100” (OD100), both from Cargill, Incorporated (Wayzata Minn.). Also useful is high oleic sunflower oil commercially available under the trade designation “TRISUN” from AHC Division of Humko Oil.

Typically, the cookware release compositions of the invention comprises a high oleic vegetable oil in an amount ranging from about 89% wt. or greater, for example, about 89 to 97% wt. based on the total weight of the high oleic vegetable oil composition and the lecithin composition. In an exemplary embodiment, the cookware release composition comprises about 93% wt. high oleic canola oil based on the total weight of the high oleic vegetable oil composition and the lecithin composition.

Lecithin Composition: Cookware release compositions of the invention comprise a lecithin composition, which may include one or more food-grade lecithins. The lecithin composition may comprise, in various embodiments, one or more types of standard lecithin and/or one or more types of modified lecithin. For example, in some embodiments, the cookware release composition comprises one or more types of standard lecithin. Examples of standard lecithin include crude, refined, filtered, bleached, deoiled, and fractionated lecithin. In other embodiments, the cookware release composition comprises one or more types of standard lecithin and one or more types of modified lecithin. Examples of modified lecithin include hydrolyzed lecithin, acetylated lecithin, and hydroxylated lecithin. When “natural” labeling is desired for the cookware release composition, the use of standard lecithin and hydrolyzed lecithin may be preferred.

Lecithin is a common name for a series of phosphatide-containing products. A phosphatide is a molecule that is similar to a triglyceride, except that the sn3 position has a phosphate group and a functional group attached, rather than a third fatty acyl chain. Major phosphatides existing in plant oils include, for example, phosphatidyl choline (PC), phosphatidyl ethanolamine (PE), phospatidyl serine, phosphatidyl glycerol, and phosphatidyl acid. Lecithin also contains non-phosphatide components including, for example, triglycerides, sterols, sterol esters, and carbohydrates.

The amounts of phosphatides in lecithin can be determined by the “acetone insolubility (AI)” method defined in American Oil Chemists' Society (AOCS) Method Ja 4-46. For example, standard soy-based lecithin typically contains about 62 to 64% wt. AI: plastic soy lecithin typically contains a minimum of about 65% to 68% wt. AI; and deoiled lecithin typically contains more than about 90% wt. AI. Various types of lecithin may be used interchangeably in formulations based on their equivalent % wt. AI. For example, a composition including 90 grams of high oleic canola oil and 10 grams of a plastic soy lecithin having 70% wt. AI will have a total of 7.0% wt. AI lecithin: to achieve the same 7.0% wt. AI content using a deoiled lecithin containing about 90% wt. AI instead of the plastic soy lecithin, the composition would include 90 grams of the oil and about 7.6 grams of the deoiled lecithin.

Embodiments of the invention comprise a lecithin composition comprising standard lecithin. As used herein the term “standard lecithin” refers to a mixture of phosphatides in oil, provided that the lecithin is not chemically modified by reaction of one or more of the phosphatides' functional groups. Standard lecithin types include crude, refined, filtered, bleached, deoiled, and fractionated lecithin. In addition to phophatides, standard lecithin may also include triglycerides, sterols, sterol esters, and carbohydrates.

Lecithin may be obtained from various animal or vegetable sources, such as soybeans, sunflowers, or egg yolk. Many commercially available lecithins are derived from soybeans and are available both in liquid form (e.g., dissolved in soybean or other edible oil) or in dry powdered form. Many lecithins are obtained from soybeans by mixing soybean oil with water, which hydrates the lecithin and renders it substantially insoluble in the soybean oil, thereby permitting centrifugal separation of the hydrated lecithin from the oil. The separated lecithin may be dried to provide a lecithin powder or may be redissolved in a suitable edible oil to provide the lecithin in liquid form.

Useful sources of standard lecithin include those commercially available under the trade designations “TOPCITHIN”, “LECIPRIME”, “LECISOY”, and “CHOCOTOP” from Cargill. Incorporated (Wayzata Minn.). TOPCITHIN UB is a standardized, liquid soybean lecithin consisting of the natural mixture of polar and nonpolar lipids.

In some embodiments, the standard lecithin comprises deoiled lecithin. Deoiled lecithin is typically prepared by treating fluid lecithin with acetone. Neutral lipids such as mono, di, and triglycerides, and free fatty acids are soluble in acetone. Thus, when lecithin is treated with acetone, the phosphatides precipitate a line, free-flowing powder. In common practice, the crude lecithin is mixed with acetone and is agitated for a period of time, after which the deoiled product is allowed to settle. The triglyceride-acetone miscella is removed, and fresh acetone is added. The procedure may be repeated until the desired acetone insoluble (AI) content of the deoiled product is reached (e.g., 95% minimum). The deoiled lecithin is then recovered, for example, by filtration. Suitable deoiled lecithin is commercially available from Cargill, Incorporated under the trade designations “EMULTOP”, “EMULPUR”, “LECIGRAN” and “LECIMULTHIN”.

In some embodiments, the standard lecithin comprises fractionated lecithin. Alcohol fractionated lecithins are commonly produced by treatment of lecithins with alcohols having different hydrophilic and lipophilic properties. Oil free lecithin can contain nearly equal proportions of phosphatidylcholine (PC), phosphatidyl ethanolamine (PE) and phosphatidylinositol (PI); the alcohol-soluble fraction shows an enrichment of PC, while the alcohol insoluble fraction is rich in PI. A commercially available fractionated/deoiled lecithin is commercially available from Cargill, Incorporated under the trade designation “METARIN”.

Modified Lecithin: Lecithin contains functional groups (e.g., double bonds) that make it reactive in a number of chemical reactions, in many embodiments, the cookware release compositions of the invention comprise one or more types of modified lecithin, for example, in combination with one or more types of standard lecithin. As used herein the term “modified lecithin” refers to lecithin molecules that have been modified by reaction of one or more of the functional groups (e.g., double bonds) of the phosphatides with one or more reagents or enzymes that modify the chemical composition of the phosphatides. In some instances a portion of the phosphatide molecules in the lecithin that is modified (e.g., hydroxylated) do not react with the modification agent to form a modified phosphatide, but rather, remains unmodified or unreacted. As used herein, a “modified lecithin” includes lecithins in which at least about 20% of the phosphatide molecules have been chemically or enzymatically modified. Representative examples of types of modified lecithin include, for example acetylated lecithin, hydroxylated lecithin, and hydrolyzed lecithin.

In some embodiments, the cookware release compositions of the invention comprise hydrolyzed lecithin (also called lysolecithin), which is a modified lecithin. Hydrolyzed lecithin can be prepared, for example, by hydrolyzing lecithin with a phopholipase enzyme, by acid hydrolysis, or by alkaline hydrolysis (saponification). In the enzymatic process, the phospholipase enzyme removes either the sn1 or sn2 fatty acyl chain, leaving a glycerol backbone with the phosphate and functional group, but with only one (i.e., rather than two) fatty acyl chains. One example of hydrolyzed lecithin is reported in U.S. Pat. No. 7,189,544 (Schmitt et al.) entitled “Enzymatic Modification of Lecithin”, the entirety of which is incorporated herein by reference. One suitable hydrolyzed lecithin is commercially available from Cargill, Incorporated under the trade designation “EMULFLUID E”.

In some embodiments, the lecithin composition comprises hydroxylated lecithin. Hydroxylated lecithin is typically obtained by acid-catalyzed addition of hydroxyl (OH) groups to sites of unsaturation (i.e., double bonds) located within the fatty acyl chains of standard lecithin. Essentially, any unsaturated fatty acid occurring within soybean oil (e.g. C18:1, C18:2, or C18:3), may be attached to the sn1 or sn2 position of soy-derived phospholipids, and may provide a potential site for hydroxyl addition. Hydroxylated lecithin may be prepared, for example, by the treatment of lecithin with hydrogen peroxide, benzoyl peroxide, lactic acid, and sodium peroxide, or by the treatment of lecithin with hydrogen peroxide, acetic acid, and sodium hydroxide. The separated fatty acid fraction of the resultant product has an acetyl value of about 30 to 38 (see, 21 C.F.R. §172.814). One suitable hydroxylated lecithin is commercially available from Cargill, Incorporated under the trade designation “EMULFLUID HL66”.

In some embodiments, the cookware release compositions comprise acetylated lecithin. Lecithin may be acetylated using acetic acid anhydride either by adding the reagent prior to degumming or by adding it to a wet gum. Acetylation occurs primarily on the amino group of phosphatidylcholine (PC). Acetylated lecithin is commercially available from Cargill, Incorporated under the trade designation “EMULFLUID A”.

Typically, modified lecithin has an acetone insolubility of about 50% wt. or greater, for example, about 52% wt. or greater, about 54% wt. or greater, about 56% wt. or greater, about 58% wt. or greater, or about 60% wt. or greater. In some embodiments, for example, hydrolyzed lecithin has an acetone insolubility of about 56% wt. or greater; and hydroxylated lecithin has an acetone insolubility of about 58% wt. or greater.

Modifications to the lecithin may improve the water dispersibility of the lecithin and may enhance its oil-in-water emulsification function. The table below compares the HLB values (i.e., hydrophilic-lipophilic balance) of various lecithins and modified lecithins.

HLB values of various commercial lecithins

| | HLB |
|---|---|
| Lecithins | Value |
| PC-depleted | 2 |
| Standard lecithin | 3 |
| De-oilled lecithin | 4-5 |
| PC-enriched lecithin | 6-7 |
| Hydrolyzed lecithin | 6-7 |
| Acetylated lecithin | 7 |
| De-oiled, hydrolyzed lecithin | 8 |
| Acetylated, hydrolyzed lecithin | 9 |

Typically, the total amount of the lecithin composition (including both the standard and modified lecithin) in the cookware release compositions ranges from about 0.5 to 12% wt., more typically ranging from about 3 to 11% wt., or ranging from about 2 to 8% wt. based on the total weight of the high oleic vegetable oil composition and the lecithin composition. The amount of the standard lecithin component typically ranges from about 1 to 7% wt., based on the total weight of the high oleic vegetable oil composition and the lecithin composition. In some embodiments, the amount of standard lecithin is kept at a level of about 5% wt. or less in order to help reduce browning of the composition. In lecithin compositions that include both standard and modified lecithin, the amount of modified lecithin typically ranges from about 2 to 7% wt. more typically ranging from about 0.5 to 4% wt., based on the total weight of the high oleic vegetable oil composition and the lecithin composition. In an exemplary embodiment, the amount of standard lecithin is about 4% wt. and the amount of modified lecithin is about 3% wt., based on the total weight of the high oleic vegetable oil composition and the lecithin composition.

Optional Ingredients: in some embodiments, the compositions of the invention include one or more optional ingredients, for example, propellants, additives, and the like.

Propellants: In some embodiments, the cookware release composition is dispensed with the aid of a propellant. Suitable propellants include food grade propellants, such as a pressurized gas, liquefied hydrocarbons, or mixtures thereof. Other suitable food grade propellants include nitrous oxide, carbon dioxide, nitrogen, propane, butane, or isobutene. Additional exemplary propellants include mixtures of propellants, such as mixtures of nitrous oxide and minor portions of other food grade propellants.

In some embodiments, the propellant is present in an amount ranging from about 10 to about 65 parts per hundred weight of a base that consists of the vegetable oil composition and the lecithin composition (referred to herein as “ppHb”). By way of example, if the combined weight of the vegetable oil composition and the lecithin composition is 100 grams (e.g., 93 grams of high oleic canola oil and 7 grams of standard lecithin), then adding 10 grams of propellant would yield 110 grams of a composition that is 10 ppHb propellant; adding 50 grams of propellant instead would yield 150 grams of a composition that is 50 ppHb propellant.

Other Additives: Cookware release compositions of the invention may optionally include various other optional ingredients including, for example, anti-foaming agents, food grade blocking agents, flavoring agents, preservatives, antioxidants, emulsifying agents, coloring agents, food grade alcohols, water, crystallization-inhibiting agents, and viscosity-reducing agents. Typically, the amount of these additives and optional ingredients range from about 10 to about 75 ppHb.

Properties: In some embodiments, the cookware release compositions of the invention display improved polymerization resistance as compared to known formulations. Polymerization resistance refers to the ability of the cookware release composition to resist polymerization when it is subjected to cooking conditions. Polymerization resistance is desirable so that the cookware release composition can be readily cleaned from the surface of the cookware after a cooking cycle. A representative cooking cycle includes applying a cookware release composition of the invention to a cooking surface and cooking at a temperature of about 290 to 400° F. for about 5 to 60 minutes. Polymerization resistance may be measured, for example, using the Washing Evaluation Testing described herein. Polymerization resistance can also be measured by measuring the increase in viscosity of a cookware release composition when exposed to heat. A testing procedure for measuring polymerization resistance by viscosity is described in the Example section of the application.

In some embodiments, the cookware release compositions of the invention display improved browning resistance as compared to known formulations. Browning resistance refers to the ability of the cookware release composition to resist changing color (i.e. browning) when exposed to cooking conditions. Browning can be reduced by reducing the amount of standard lecithin that is included in the cookware release composition. In order to reduce browning, it is typically desirable to include about 8% wt. lecithin composition or less, preferably no more than about 5% wt. standard lecithin, in a cookware release composition. Browning of a cookware release composition can be measured using a U.V.-Vis spectrophotometer.

Cookware release compositions of the present invention may be used with different cooking temperatures and durations, food items, and baking, frying, and cooking needs. For example, the cookware release compositions of the invention may be applied to cookware that is used to bake food items at a temperature from about 290° F. to about 450° F. for up to about 60 minutes (e.g., about 5-60 minutes, about 10-50 minutes, about 20-45 minutes or about 30-45 minutes). The compositions of the present invention may also be applied to cookware, such as a frying pan or skillet that is used to prepare food items (e.g., eggs or pancakes) at similar temperatures for about 5 minutes or greater. Cooking surfaces or utensils in both cooking examples may be coated with the composition of the present invention to reduce or eliminate browning at typical cooking temperatures and durations.

A food item can be prepared using a cookware release composition according to the present invention. Initially, an oil and a cookware release agent comprising a standard lecithin and/or a modified lecithin are provided. The cookware release agent and the oil are mixed together, along with any other optional additives, to form the cookware release composition. The mixture may be dispensed onto a cookware surface or mold, e.g., by spraying from an aerosol container with a propellant. The food item is applied onto the coated cookware surface, and the coated cookware surface and the food item are heated to cooking temperatures for cooking durations suitable for the food item. Of course, persons of ordinary skill in the art will recognize that the previously recited steps can be performed in different orders.

In an exemplary high throughput commercial cooking process, the cookware release composition of the invention is applied to a cooking surface of a food cooking apparatus. After application, a food composition (e.g., an egg) is then placed in contact with the coated cooking surface. Heat is applied to the cooking surface in order to cook the food composition to the desired degree; the temperature and time used to cook the food will vary depending on the type of food being prepared. After the cooking is complete, the cooked food composition is removed from the cooking surface, and the cooking surface is treated for reuse. In some embodiments, the cooking surface is treated by being cleaned (e.g., washed), and the cooking release composition is then reapplied before the cooking surface is again contacted with a food composition. In other embodiments, a fresh coating of the cookware release composition is applied directly to the cooking surface without prior washing, and the cooking surface is again contacted with a food composition for cooking. This may be repeated for several cycles before a washing cycle is conducted. It is believed that the prolonged single heating tests described in the Example section of the application are predictive of the polymerization that may occur in such exemplary commercial processes. Improved polymerization resistance of the compositions of the invention may allow the commercial operator to increase the number of cooking cycles possible between each wash cycle, reduce the intensity of the wash cycle, or both.

The invention will now be described with reference to the following non-limiting examples.

### EXAMPLES

TABLE 1
Description of Ingredients Used in Preparing Cookware Release Compositions

| | | | | Acetone | |
|---|---|---|---|---|---|
| | | | | Insolubles | |
| General Term | Abbreviation | Product Name | Manufacturer Name | (% wt. AI) | Fatty Acid Profile |
| High-Oleic | CV65 | Clear Valley 65 High- | Cargill Specialty | NA | C16-0 (4.1% wt.) |
| Canola Oil | | Oleic Canola Oil | Canola Oils | | C18-0 (2.0% wt.) |
| | | | | | C18-1 (63.1% wt.) |
| | | | | | C18-2 (24.4% wt.) |
| | | | | | C18-3 (3.2% wt.) |
| High-Oleic | CV75 | Clear Valley 75 | Cargill Specialty | NA | C16-0 (3.5% wt.) |
| Canola Oil | | Higher-Oleic Canola | Canola Oils | | C18-0 (1.9% wt.) |
| | | Oil | | | C18-1 (74.2% wt.) |
| | | | | | C18-2 (14.1% wt.) |
| | | | | | C18-3 (3.1% wt.) |
| Standard | T | Topeithin UB | Cargill Texturizing | 62-63 | NA |
| Lecithin | | | Solutions | | |
| Hydroxylated | H | Emulfluid HL66 | Cargill Texturizing | 60.4 | NA |
| Lecithin | | | Solutions | | |
| Hydrolyzed | E | Emulfluid E | Cargill Texturizing | 58.1 | NA |
| (Lyso) | | | Solutions | | |
| Lecithin | | | | | |
| Acetylated | A | Emulfluid A | Cargill Texturizing | 60 | NA |
| Lecithin | | | Solutions | | |

### Example 1

### Resistance to Polymerization—Washing Evaluation Test

The purpose of this test is to determine the extent of polymerization induced by oxidative and thermal pressures. When oil polymerization reaches an advanced stage, there is a very obvious and significant change in the observable physical properties. This change may be best characterized as something akin to solidification; the oil loses its liquid flow properties and may eventually become a hardened film. The “Washing Evaluation Test” was designed to use a very small amount of the sample (˜0.2 grams in 47 mm aluminum weigh dish) of a test sample that typically includes oil and/or lecithin. Reducing the amount of sample used in the test results in an acceleration of the thermal and oxidative effects impacting the oils. Smaller sample volume results in a thinner layer on the surface of the dish, and consequently a higher percentage of the sample being exposed to the atmosphere at any given time. Although these accelerated test conditions do not exactly replicate commercial production conditions, they are believed to be reasonably reliable predictors of performance in a production setting. The Washing Evaluation Test is described below.

Washing Evaluation Test: 7 drops (˜0.2 grams) of a sample composition is placed in a pre-weighed aluminum weigh dish using a disposable pipette. The dish containing the sample is then placed on a baking sheet and is baked at 375° F. for a period of 1 hour in a convection oven (Blodgett Dual Flow Convection Oven) on low convection setting. After baking, the dish together with the baked sample composition are reweighed, and the weight is recorded.

Washing of the dish begins 20 minutes after it has been removed from the oven. A large stainless steel bowl is filled with hot water (104° F.; 40° C.), and a small amount ˜2 mL of dish soap (PANTASTIC detergent from Ecolab Co.) is added. The faucet is left running at a low rate, and portions of dish soap are added at two-minute intervals for the duration of the washing. The scrubbing tool utilized is a coarse, non-abrasive sponge, e.g., the spongy, less abrasive side of a SCOTCH-BRITS Heavy Duty Scrub Sponge (3M Company, St. Paul, Minn.). The sponge is cut into a circular shape that fits into the dish such that its entire surface is in contact with the baked composition present on the surface of the dish. A binder clip is clamped onto the opposite side of the circular sponge (e.g., the abrasive side of the SCOTCH-BRITE sponge mentioned above) for use as a handle. During the wash, the dish is submerged in the stainless steel bowl. The dish is scrubbed by rotating the sponge opposite the dish at a consistent rate using high hand pressure. Each dish is washed for 30 seconds, and then rinsed quickly under the running faucet. After a dish is washed, it is placed upside down on a paper towel to dry. After all dishes have been washed, a paper towel is used to dry the underside of each dish. The dishes are then placed back on the baking sheet, and returned to the oven (200° F. for 1 min) for drying. The dried dishes are then weighed on the analytical balance. The portion of the sample that remains on the dish is deemed to have been polymerized.

The percent oil washed from the surface of the dish is calculated from the three weights obtained during the experiment (M_{P}=mass of aluminum dish (tare). M_{p+B}=mass of aluminum dish and oil after baking, M_{P+W}=mass of aluminum dish and oil after washing) according to the equation:

% Composition Removed=((M_{B}−M_{w})/M₁₃)×100%

where

M_{B}=mass of oil baked onto dish=(M_{P+B}−M_{P})

M_{W}=mass of oil remaining on dish after washing=(M_{P+W}−M_{P})

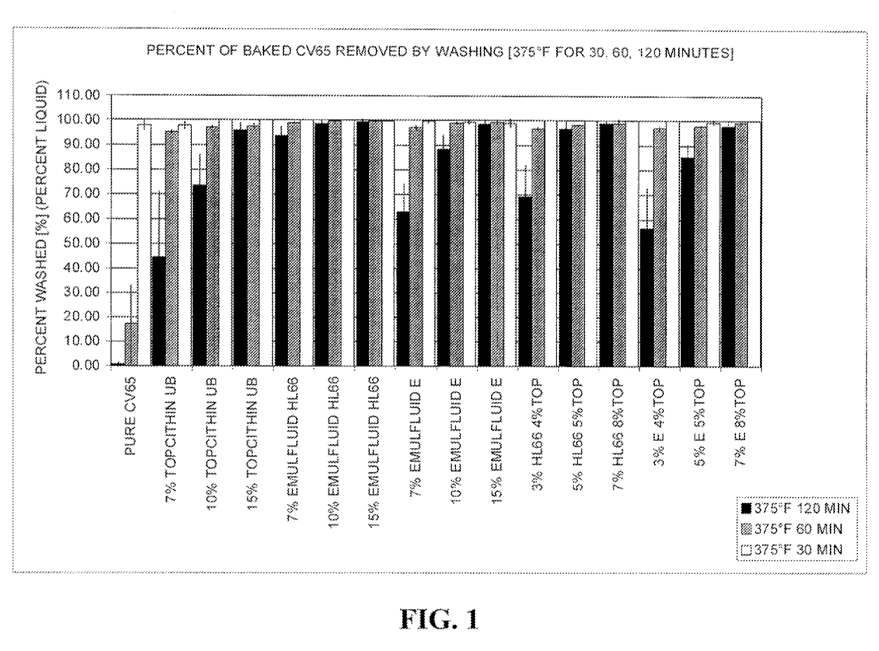

The samples listed in Table 2 were tested using the Washing Evaluation Test. The sample naming convention in Table 2 identifies the oil being used (CVOS in this case) and the % wt. of each type of lecithin (T, H, and E), using the abbreviations in Table 1. This same naming convention is used in identifying formulations of various test samples in the examples below. The results of the Washing Evaluation Test are set forth in Table 2A and shown graphically in FIG. 1.

TABLE 2

| | | Standard Lecithin | | Modified Lecithin | |
|---|---|---|---|---|---|
| | High Oleic | % wt. | | % wt. | |
| Sample Name | Vegetable Oil | (% wt. AI) | | (% wt. AI) | |
| CV65 | 100% CV65 | — | | — | |
| CV65 7T | 93% CV65 | 7% | wt. T | — | |
| | | (4.3% | wt. AI) | | |
| CV65 10T | 90% CV65 | 10% | wt. T | — | |
| | | (6.2% | wt. AI) | | |
| CV65 15T | 85% CV65 | 15% | wt. T | — | |
| | | (9.3% | wt. AI) | | |
| CV65 7H | 93% CV65 | — | | 7% | wt. H |
| | | | | (4.2% | wt. AI) |
| CV65 10H | 90% CV65 | — | | 10% | wt. H |
| | | | | (6.0% | wt. AI) |
| CV65 15H | 85% CV65 | — | | 15% | wt. H |
| | | | | (9.0% | wt. AI) |
| CV65 7E | 93% CV65 | — | | 7% | wt. E |
| | | | | (4.1% | wt. AI) |
| CV65 10E | 80% CV65 | — | | 10% | wt. E |
| | | | | (5.8% | wt. AI) |
| CV65 15E | 85% CV65 | — | | 15% | wt. E |
| | | | | (8.7% | wt. AI) |
| CV65 4T3H | 93% CV65 | 4% | wt. T | 3% | wt. H |
| | | (2.5% | wt. AI) | (1.8% | wt. H) |
| CV65 5T5H | 90% CV65 | 5% | wt. T | 5% | wt. H |
| | | (3.1% | wt. AI) | (3.0% | wt. AI) |
| CV65 8T7H | 85% CV65 | 8% | wt. T | 7% | wt. H |
| | | (5.0% | wt. AI) | (4.2 wt. | % AI) |
| CV65 4T3E | 93% CV65 | 4% | wt. T | 3% | wt. E |
| | | (2.5% | wt. AI) | (1.7 wt. | % AI) |
| CV65 5T5E | 90% CV65 | 5% | wt. T | 5% | wt. E |
| | | (3.1% | wt. AI) | (2.9 wt. | % AI) |
| CV65 8T7E | 85% CV65 | 8% | wt. T | 7% | wt. E |
| | | (5.0% | wt. AI) | (4.1% | wt. AI) |

TABLE 2A
Results

| | % of Composition Removed by | | |
|---|---|---|---|
| | Washing Evaluation Test | | |
| Sample Name | 30 min | 60 min | 120 min |
| CV65 | 98 | 17 | 1 |
| CV65 7T | 98 | 95 | 45 |
| CV65 10T | 100 | 97 | 73 |
| CV65 15T | 100 | 98 | 96 |
| CV65 7H | 100 | 99 | 94 |
| CV65 10H | 100 | 100 | 99 |
| CV65 15H | 100 | 100 | 100 |
| CV65 7E | 100 | 97 | 63 |
| CV65 10E | 100 | 99 | 88 |
| CV65 15E | 99 | 99 | 99 |
| CV65 4T3H | 100 | 97 | 69 |
| CV65 5T5H | 100 | 98 | 97 |
| CV65 8T7H | 100 | 99 | 99 |
| CV65 4T3E | 100 | 97 | 56 |
| CV65 5T5E | 100 | 98 | 85 |
| CV65 8T7E | 100 | 99 | 98 |

It was observed that the lecithinated formulas displayed very little polymerization until the 120-minute test (Blue). This test demonstrates that highly aggressive thermal abuse is required to polymerize CV65 lecithin blends.

### Example 2

### Resistance to Polymerization of Certain Oil Lecithin Blends

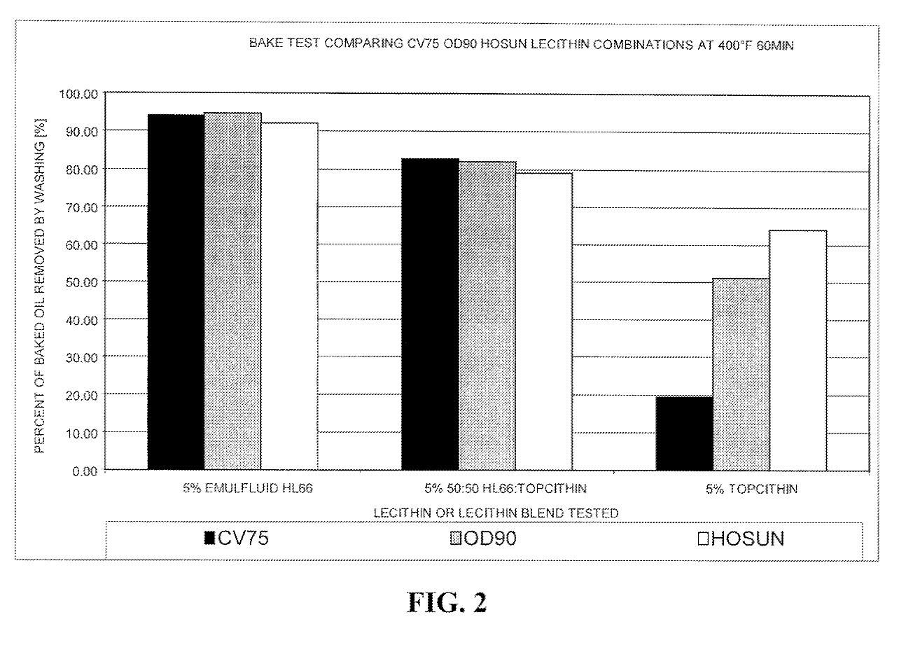

Certain compositions were tested using the Washing Evaluation Test to investigate behavior of oils in the presence of various lecithin compositions. The results are provided in FIG. 2. The same compositions were heated for 72 hours at 295° F. and the viscosity was measured at 67° F. The viscosity data is provided in Table 3.

TABLE 3

| | | Viscosity |
|---|---|---|
| | | Cps at 67° F. after |
| | | holding 72 hours at |
| BASE OIL | LECITHIN | 295° F. |
| CV75 | 5% EMULFLUID HL66 | 369 |
| | 2.5% EMULFLUID HL66: | 188 |
| | 2.5% TOPCITHIN | |
| | 5% TOPCITHIN | 1022 |
| OD90 | 5% EMULFLUID HL66 | 215 |
| | 2.5% EMULFLUID HL66: | 480 |
| | 2.5% TOPCITHIN | |
| | 5% TOPCITHIN | 292 |
| HOSUN | 5% EMULFLUID HL66 | 282 |
| | 2.5% EMULFLUID HL66: | 214 |
| | 2.5% TOPCITHIN | |
| | 5% TOPCITHIN | 655 |

This data showed that blends of hydroxylated and standard lecithin with high oleic oils had lower viscosities as compared to blends of the individual lecithin compositions with the same high oleic oil.

### Example 3

### Resistance to Polymerization Rheology Testing

The purpose of this test is to monitor polymerization as manifested by viscosity increase. There will also be a correlation between increases in viscosity and decreases in release effectiveness. Basically, low viscosities will correspond to good pan-release and polymerization properties while increases in viscosity are believed to indicate that polymerization is occurring and release effectiveness is diminishing. Viscosity was measured using an Anton Paar MCR 300 rheometer, in combination with concentric cylinder spindle geometry. The rheometer measures viscosity as follows: a spindle (geometry) is lowered into the liquid sample, and a precisely monitored torque is applied to turn the spindle. The rheometer calculates viscosity based on the fluid's resistance to movement of the spindle. Samples were heated (T=146° C.) for 72 hours to see if viscosity changed.

Test Method
1. A 200 mL portion of each of four formulas was prepared by directly pouring/pipetting the components into a dedicated 250 mL Nalgene bottle.
2. For samples including lecithin, the lecithin was added after the oil to minimize adhesion to the bottle's interior surface.
3. The bottles were shaken vigorously for about 60 seconds to improve homogeneity.
4. 50 mL of each formulation was added to each of three 500 mL Erlenmeyer Flasks, yielding 12 total flasks.
5. 20 mL of each formulation was poured directly into a separate rheometer cup for immediate rheometric analysis (these were t=0 samples).
6. The 12 Erlenmeyer Flasks, each containing 50 mL of sample, were placed into an incubator and heated to 146° C.
7. An Erlenmeyer Flask of each formula was pulled every 24 hours.
8. These samples were allowed to equilibrate for 1 hour at room temperature, after which sample viscosity was measured.

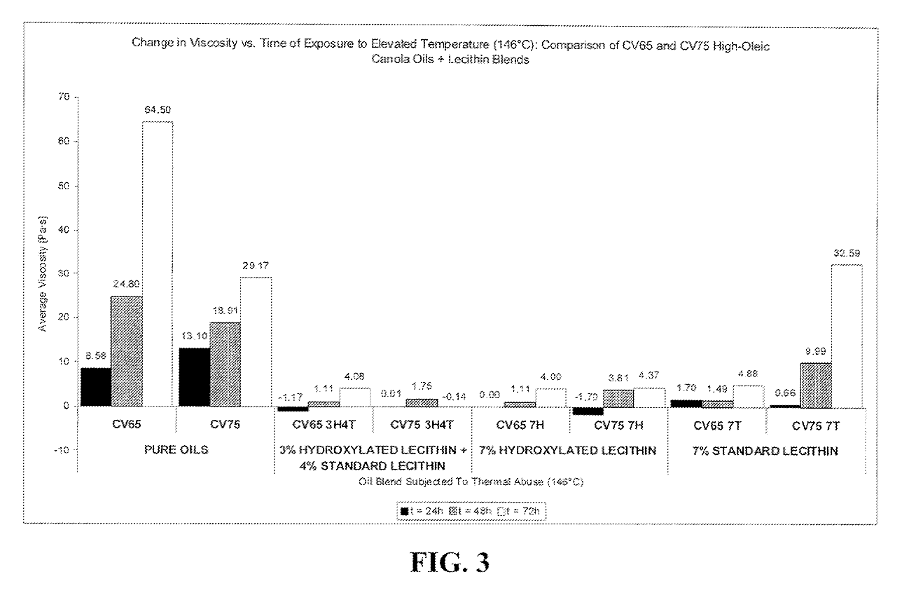

The results of the rheology testing are shown in FIG. 3.

Observations
1. The sample with 3% hydroxylated lecithin and 4% standard lecithin (“3H4T” in FIG. 3) and 7% hydroxylated lecithin (“7T” in FIG. 3) maintained a relatively consistent viscosity throughout the 72 hours of observation.
2. The pure oils and CV75 7T showed significant increases in viscosity upon heating.
3. In production test for egg cooking, 7% H formula had a yield less than 90% due to poor releasing while the formula containing 3% H and 4% T (“3H4T”) improved the yield over 95%.

This latter observation highlights one benefit of lecithin compositions in accordance with embodiments of the invention. In particular, a lecithin formulation comprising only standard lecithin is more prone to polymerize than is a blend of standard and modified lecithins: modified lecithin (hydroxylated lecithin in this example) is less prone to polymerize, but has inferior release performance. Therefore, it is preferred to use a lecithin composition comprising a mixture of hydroxylated lecithin and non-modified lecithin in order to provide both good release properties and polymerization reduction.

### Example 4

### Egg Frying Testing

The target of this test was to evaluate the efficiency of high oleic canola oil and lecithin blends as pan-release agents for use in egg frying applications. The method of testing was intended to parallel the preparation of a “sunny-side up” egg in a standard frying pan. Effectiveness of a particular blend was based upon performance in two key areas (1) whether the formula facilitated release of the egg from the pan's surface, and (2) the extent of the browning imparted upon the egg. Success or failure, in regard to the critical performance aspects of release and browning, was determined qualitatively according to the following metrics:

Answer

| Question | Yes | No |
|---|---|---|
| Is the egg removed from the pan without | Pass | Fail |
| the assistance of any utensils? | | |
| Is there an unnatural or unappealing | Fail | Pass |
| amount of browning on the cooked egg? | | |

Method
1. The test utilized pans of two different compositions: (1) poor-quality/abused Teflon and (2) stainless steel.
2. Each pan was placed over an electric burner and was heated to a temperature of about 300° F.
3. Approximately 1 mL of oil blend was added to each pan using a disposable transfer pipette.
4. The pans were tilted and rotated to ensure that a uniform oil coating was applied to the surface of the pan.
5. The egg was cracked into the center of the pan and was allowed to cook for approximately 60 seconds.
6. Alter 60 seconds the pans were shaken laterally to see if there was adhesion to the surface of the pan.
7. The egg was then subjected to additional heating for 4 minutes in order to determine the full extent of browning. Browing was measured using a UV-Vis spectrophotometer (Lambda 45 from Perkin Elmer Co.).
8. The egg was retained for future comparison and the pan was cleaned before repeating experiment.

Summary of Results

Formulations are abbreviated according to (BASE OIL. % LECITHIN, HY=HIGH YIELD (i.e., containing water): AS=AEROSOL SPRAY).

| | Teflon Surface | | Stainless Steel Surface | |
|---|---|---|---|---|
| | Facilitation | Observation | Facilitation | Observation |
| Formulation | of Release | of Browning | of Release | of Browning |
| CV65 | NO | NO | NO | NO |
| Formula 1 | YES | NO | YES | NO |
| CV65 3H4T | | | | |
| Formula 2 | YES | NO | YES | NO |
| CV65 3H4T | | | | |
| Formula 3 | YES | SLIGHT | YES | SLIGHT |
| CV65 3E4T | | | | |
| Formula 4 | YES | SLIGHT | YES | SLIGHT |
| CV65 3E4T | | | | |
| Formula 5 | YES | YES | NO | YES |
| CV65 5H5T | | | | |
| Formula 6 | YES | YES | NO | YES |
| CV65 5E5T | | | | |
| CV65 | NO | NO | NO | NO |
| Formula 7 | YES | SLIGHT | NO | YES |
| CV65 5T | | | | |
| Formula 8 | YES | SLIGHT | YES | YES |
| CV65 3H5T | | | | |
| Formula 9 | YES | NO | YES | NO |
| CV75 3H4T | | | | |
| Formula 10 | YES | NO | YES | NO |
| 3CV65 3H4T | | | | |
| Formula 11 | YES | SLIGHT | YES | SLIGHT |
| CV65 3H5T | | | | |
| Formula 12 | YES | NO | YES | NO |
| CV75 7A AS | | | | |
| Formula 13 | YES | NO | YES | NO |
| CV75 3A4T | | | | |
| AS | | | | |
| Formula 14 | YES | YES* | YES | YES* |
| CV75 7A | | | | |
| HY AS | | | | |
| Formula 15 | YES | YES* | YES | YES* |
| CV75 3A4T | | | | |
| HY AS | | | | |

AS = 93% wt. oil type as specified; 7% wt. total lecithin composition as specified; 0.003 ppHb silicone (DC-200 from Dow Corning Co.); 19 ppHb propellant (A-70).
HY AS = 93% wt. oil type as specified; 7% wt. total lecithin composition as specified; 215 ppHb water; 0.17 ppHb sorbic acid; 0.10 ppHb potassium sorbate; 69.2 ppHb propellant (A-55). HY AS contributed to an aesthetically undesirable texture on the cooked egg (unnatural appearance).

Observations
1. Acetylated lecithin exhibited good release properties in Formulas 13 and 14.
2. Formulations 3 and 4 are replicates demonstrating better release as compared to Formula 7. Formula 8 also had better release properties than Formula 7, but more browning was observed as compared to Formulae 3 and 4.

3. Less than 8% wt. lecithin is preferred for desired pan release and browning properties.

### Example 5

### Effect of Lecithin on Polymerization of High Oleic Oils

Testing was conducted in order to determine the effect of lecithin on polymerization of sample vegetable oils including generic canola oil (Wesson Canola), high oleic canola oils (CV65, CV75), and high oleic sunflower oil (HOSUN). The composition of the oils tested are summarized below. The lecithin used for all samples was standard lecithin (TOPCITHIN) at a level of 7% wt.

| | Fatty Acid Composition of Oils | | | | |
|---|---|---|---|---|---|
| | (% wt.) | | | | |
| Oil Composition | C16-0 | C18-0 | C18-1 | C18-2 | C18-3 |
| Palm Olein | 40 | 5 | 43 | 12 | <0.5 |
| Wesson Canola | 4.4 | 1.5 | 64.8 | 19.1 | 7.4 |
| CV65 | 4.1 | 2.0 | 63.1 | 24.4 | 3.2 |
| CV75 | 3.5 | 1.9 | 74.2 | 14.1 | 3.1 |
| HOSUN | 4.0 | 4.0 | 82.0 | 8 | <0.5 |

Source: CV65, CV75, Generic Canola, and HOSUN were analyzed by Cargill, Incorporated. Palm olein data was taken from American Palm Oil Council.

Method

The oils were tested using the Washing Evaluation Test, as described hereinabove, except that the baking temperature was modified to 400° F. for a period of 1 hour. Two layouts (layouts A and B) were used in order to randomize any positioning effects within the oven.

Observations

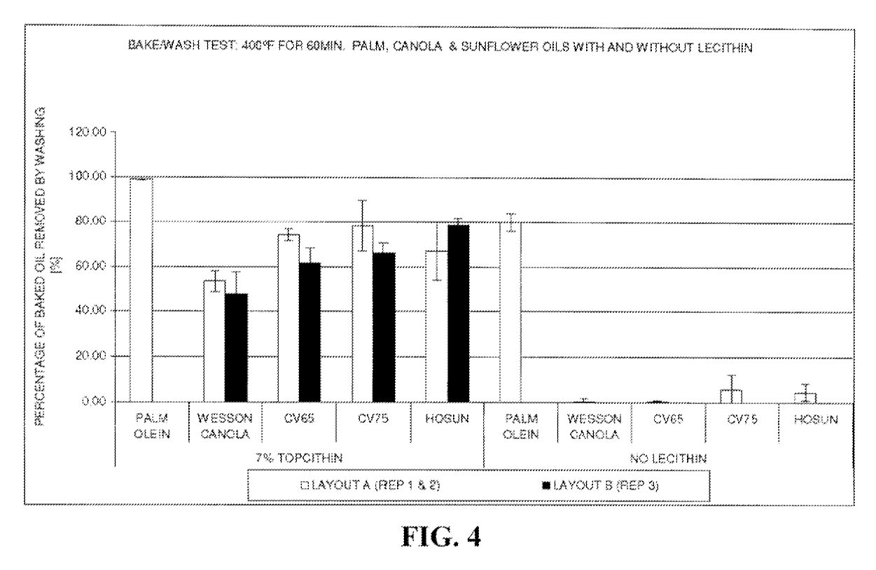

The results of the Wash Evaluation Test are summarized in FIG. 4. As shown in FIG. 4, palm olein did not stick to the baking pans and was nearly completely removed from the surface of the pans in all cases. Generic canola oil (Wesson), high oleic canola oil (CV65, CV75), and high oleic sunflower oil (HOSUN) all without lecithin formed a polymerized film and were not removed from the surface of the pans after baking for 1 hour. However, as shown in FIG. 4, the testing showed that in the presence of lecithin (Topcithin), the oils performed better during baking, resulting in less polymerization and a higher percentage of baked oil removed by washing. The decrease in polymerization was better for the oils that were high in oleic acid content (i.e., CV65, CV75, and HOSUN) as compared to generic canola oil (i.e., Wesson Canola). This is a surprising result in view of the fact that oleic acid has a high content of polymerizable double bonds.

Other embodiments of this invention will be apparent to those skilled in the art upon consideration of this specification or from practice of the invention disclosed herein. Various omissions, modifications, and changes to the principles and embodiments described herein may be made by one skilled in the art without departing from the true scope and spirit of the invention which is indicated by the following claims.

What is claimed is:

1. A cookware release composition comprising (i) a high oleic vegetable oil composition comprising canola oil, sunflower oil, or a mixture thereof having about 70% wt. or greater oleic acid; and (ii) about 0.5 to 12% wt. lecithin composition, based on the total weight of the high oleic vegetable oil composition and the lecithin composition;
wherein the cookware release composition is capable of being coated on a generally smooth aluminum cooking surface, held at a temperature of at about 290° F. for about 5 minutes, and having at least about 70% of the cookware release composition washed off by the Washing Evaluation Test.

2. The cookware release composition of claim 1, wherein the temperature is at least about 325° F.

3. The cookware release composition of claim 1, wherein the time is at least about 30 minutes.

4. The cookware release composition of claim 1, wherein the high oleic vegetable oil composition comprises about 15% wt. or less saturated fatty acids.

5. The cookware release composition of claim 1, wherein the high oleic vegetable oil composition comprises canola oil.

6. The cookware release composition of claim 1, wherein the lecithin composition comprises standard lecithin, modified lecithin, or a mixture thereof.

7. The cookware release composition of claim 1, further comprising a food-grade blocking agent.

8. The cookware release composition of claim 1, further comprising a propellant.

9. A cookware release composition comprising: (a) a high oleic vegetable oil composition comprising about 63% or greater oleic acid; and (b) a lecithin composition that comprises (i) one or more types of standard lecithin; and (ii) one or more types of modified lecithin.

10. The cookware release composition of claim 9, wherein the modified lecithin is selected from the group consisting of hydrolyzed lecithin, acetylated lecithin, and hydroxylated lecithin.

11. The cookware release composition of claim 9, wherein the high oleic vegetable oil comprises about 70% wt. or greater oleic acid.

12. The cookware release composition of claim 9, wherein the high oleic vegetable oil comprises about 4.0% wt or less linolenic acid.

13. The cookware release composition of claim 9, wherein the high oleic vegetable oil comprises about 15% wt. or less saturated fatty acids.

14. The cookware release composition of claim 9, wherein the high oleic vegetable oil composition comprises canola oil, sunflower oil, olive oil, olive-pomance, safflower oil, or a mixture thereof.

15. The cookware release composition of claim 9, wherein the cookware release composition comprises about 5% wt. or less standard lecithin, based on a total weight of the high oleic vegetable oil composition and the lecithin composition.

16. The cookware release composition of claim 9, wherein the composition comprises about 89 to 97% wt. high oleic vegetable oil composition, based on a total weight of the high oleic vegetable oil composition and the lecithin composition.

17. The cookware release composition of claim 9, wherein the composition comprises about 3 to 11% wt. lecithin composition based on a total weight of the high oleic vegetable oil composition and the lecithin composition.

18. The cookware release composition of claim 9, wherein the lecithin composition comprises about 1 to 7% wt. standard lecithin and about 2 to 7% wt. modified lecithin, based on a total weight of the high oleic vegetable oil composition and the lecithin composition.

19. The cookware release composition of claim 9, wherein the composition comprises about 89 to 97% wt. high oleic vegetable oil; and about 3 to 11% wt. lecithin composition, based on a total weight of the high oleic vegetable oil composition and lecithin composition.

20. The cookware release composition of claim 9, wherein the cookware release composition is capable of being coated on a generally smooth aluminum cooking surface: held at a temperature of about 325° F. for a time of about 30 minutes; and having about 70% or greater of the cookware release composition washed off by the Washing Evaluation Test.

21. A method of reducing polymerization of a cookware release composition during cooking at a temperature of at least about 290° F. for a time of about 5 minutes or greater; the method comprising applying to a cooking surface a cookware release composition comprising (i) a high oleic canola oil composition comprising canola oil, sunflower oil, or a mixture thereof having an oleic acid content of about 70% wt. or greater; and (ii) about 0.5 to 12% wt. lecithin composition, based on the total weight of the high oleic vegetable oil composition and lecithin composition.

22. A cooking method comprising:
a) applying a cookware release composition to a cooking surface of a substrate to form a coated surface, the cookware release composition comprising (i) a high oleic vegetable oil composition comprising canola oil, sunflower oil, or a mixture thereof having about 70% wt. or greater oleic acid; and (ii) about 0.5 to 12% wt. lecithin composition, based on the total weight of the high oleic vegetable oil composition and the lecithin composition;
b) heating the substrate and the applied cookware release composition at a temperature of at least about 290° F. for a time of at least about 5 minutes; and
c) washing the coated surface.

23. The method of claim 22, wherein washing the coated surface removes at least 20% more of the cookware release coating, on a weight basis, than a cookware release coating in which the vegetable oil composition comprise canola oil having less than about 63% wt. oleic acid and greater than 15% wt. saturated fatty acids.

24. The method of claim 22, further comprising depositing a food on the coated surface, wherein heating the substrate and the applied pan release composition further comprises heating the food.

25. A method for producing a cookware release composition, comprising combining a high oleic vegetable oil, a first lecithin component, and a second lecithin component, wherein the first lecithin component comprises a standard lecithin and the second lecithin component comprises at least one modified lecithin that has been reacted to modify at least one functional group of at least about 20% of the phosphatides.

26. The method of claim 25, wherein the modified lecithin is selected from the group consisting of hydrolyzed lecithin, acetylated lecithin, and hydroxylated lecithin.
